(19) United States
(12) Patent Application Publication
(10) Pub. No.: US 2019/0261475 A1
(43) Pub. Date: Aug. 22, 2019

(54) METHOD OF USING A HIGH REACTANCE, INDUCTOR TRANSFORMER TO PASSIVELY REDUCE FLICKERING, CORRECT POWER FACTOR, CONTROL LED CURRENT, AND ELIMINATE RADIO FREQUENCY INTERFERENCE (RFI) FOR A CURRENT-DRIVEN LED LIGHTING ARRAY INTENDED FOR USE IN STREETLIGHT MESH NETWORKS

(71) Applicant: John K. Grady, Ayer, MA (US)

(72) Inventor: John K. Grady, Ayer, MA (US)

(21) Appl. No.: 16/276,724

(22) Filed: Feb. 15, 2019

Related U.S. Application Data
(60) Provisional application No. 62/631,542, filed on Feb. 16, 2018.

(51) Int. Cl. H05B 33/08; H01F 38/10; F21S 8/08

(52) U.S. Cl. CPC H05B 33/0818; H05B 33/0887; F21W 2131/103; F21S 8/085; H01F 38/10

(57) ABSTRACT

A circuit for powering an LED lighting array, the circuit comprising: a transformer for receiving AC line current and stepping down the voltage; one of a rectifier bridge or tapped secondary windings of the transformer paired with steering diodes, for providing a varying DC current; an inductor for receiving the varying DC current so as to smooth out the varying DC current with respect to both voltage and current; and a electrical connection for directing the smoothed-out DC current to the LED lighting array to power the LEDs.

### REFERENCE TO PENDING PRIOR PATENT APPLICATION

This patent application claims benefit of pending prior U.S. Provisional Patent Application Ser. No. 62/631,542, filed Feb. 16, 2018 by John K. Grady for METHOD OF USING A HIGH REACTANCE, INDUCTOR TRANSFORMER TO PASSIVELY REDUCE FLICKERING, CORRECT POWER FACTOR, CONTROL LED CURRENT, AND ELIMINATE RADIO FREQUENCY INTERFERENCE (RFI) FOR A CURRENT DRIVEN LED LIGHTING ARRAY INTENDED FOR USE IN STREETLIGHT MESH NETWORKS (Attorney's Docket No. GRADY-5 PROV), which patent application is hereby incorporated herein by reference.

### FIELD OF THE INVENTION

This invention relates to lighting fixtures in general, and more particularly to larger LED (Light Emitting Diode) lighting fixtures.

### BACKGROUND OF THE INVENTION

LED lighting fixtures in the 10 to 200 watt LED power range, such as those which might be used for area lighting, street lighting, and/or high bay lighting, presently utilize power semiconductor-based electronic controls to achieve DC currents that are then regulated in known ways to power the LEDs, which are often multiples of LED strings arranged in series. These electronic systems mimic a constant current source, usually driving the LEDs close to regulated maximum current ratings in order to achieve high outputs.

There is a factor of 2, approximately, when considering the light output of LED lamps vs. gas-discharge lamps (e.g., fluorescent or sodium lamps), so a 200 watt LED array might provide about the same light output as a 400 watt gas-discharge lamp for roadway lighting.

Generally, producing the DC rail for powering an LED lamp from the AC power line available from the electrical utility involves power factor correction (PFC) circuitry to meet International Electrotechnical Commission (IEC) regulations and other regulations, as well as to provide harmonic suppression. Both the PFC circuitry and the current regulation circuitry (to mimic a constant current source for driving the LEDs) tend to use well known high frequency semiconductor switching circuitry similar to often-problematic computer power supplies to reduce the cost and size of the fixture parts, but this comes at a cost in another area. More particularly, high frequency semiconductor switching circuitry can radiate copious, often intractable broadband radio frequency interference (RFI) unless it is carefully shielded and filtered (generally requiring expensive parts), and the high frequency semiconductor switching circuitry is difficult to operate over a wide range of input voltages while maintaining peak efficiency. The high frequency semiconductor switching circuitry, and related close-coupled inductors, are generally fragile with respect to input voltage spikes, therefore also requiring costly high power spike suppression components and filter networks.

Radio frequency (RF) interference from the high frequency semiconductor switching circuitry for a 200 watt LED lamp can be highly problematic for poletop-mounted, or streetlight fixture-mounted, radio-based mesh network systems (e.g., Wi-Fi network systems), as it interferes with reception of the weak “back haul” signal from a distant Wi-Fi user with a low power transmitter. This can be particularly problematic in view of the growing proliferation of mesh network systems (e.g., Wi-Fi network systems) that draw their radio power from a streetlight head. If the streetlight interferes with radio-based mesh network reception and thus communications, many expensive-to-fix, and technically difficult, intermittent network problems can arise. In this respect it is noted that where the radio-based mesh network system is poletop-mounted, and particularly where the radio-based mesh network system is streetlight fixture-mounted, the highly sensitive reception channels of the radio-based mesh network system antenna may be only 8 inches or so away from the RF-emitting streetlight head. It is further noted that gaining access to a streetlight head in a city may cost thousands of dollars in access costs, such as police details or lift trucks, making intermittent network problems particularly problematic. Thus, there is a need for a technically improved approach for producing the DC current for an LED lamp which does not interfere with an adjacent radio-based mesh network system, particularly where the LED lamp and the radio-based mesh network system are poletop-mounted and adjacent to, or physically coupled to, one another.

These common DC-based LED lighting circuits also utilize electrolytic DC filter capacitors, since in the final analysis, single phase power is pulsating in nature and LEDs require close, constant DC levels due to low thermal mass. Thermal averaging is not allowed; this implies energy storage in the fixture. These electrolytic capacitors are inherently (and notoriously) unreliable components—even the best electrolytic capacitors are typically rated at only 1000 to 3000 hours life at constant temperature. Claims of LED lighting fixture life of 50,000 hours are, therefore, highly suspect—not because of the LEDs themselves, but due to the poorly thought-out, complex support circuitry using these electrolytic capacitors.

More particularly, an electrolytic capacitor is chemically active and is typically semi-hermetically sealed to its electrical connecting leads by a compressed rubber washer. The electrolytic capacitor has a wet semi-solid paste inside. As a result, electrolytic capacitors typically suffer from “drying out” and electrolyte leakage. In addition, certain temperature-varying environments (e.g., a streetlamp environment) can be very hard on an electrolytic capacitor, inasmuch as a wet electrolytic capacitor may be exposed to temperatures below 0 degrees F. and above 170-210 degrees F. in daily cyclical use (e.g., next to an LED lighting array that gets hot/cold during daily on/off use). These temperature differentials cause constant changes in the internal pressure of the electrolytic capacitor, exacerbating problems with drying out and leakage due to repetitive pressure/vacuum cycles. As of 2016, several major manufacturers of LED lamps have had widespread and expensive warrantee failures due to the failure of electrolytic capacitors. The response has been to reduce the warrantee on full fixtures to approximately 14,000 hours (5 years); one should note that sodium streetlamps are warranteed for 24,000 hours, and typically survive longer, and fluorescent tubes now can be had for 40,000 or 50,000 hours life. A reliable RFI-free power supply for LED lamps is thus a major priority. It is a specific aim of this invention to eliminate electrolytic capacitors in favor of inductive energy storage and smoothing.

There are also approaches using AC power in longer, lower wattage LED strings with steering diodes or back-to-back connections, like decorative Christmas LED strings (but on a higher power scale). The LEDs must be de-rated significantly from the DC average thermal rating, and rough regulation by series passive, or small range active ballasting, is used. This de-rating is a factor of about 2.6 (to 38%), as the LED junctions are too small thermally to average out any AC heat peaks that are any higher than the rated DC maximum level, at frequencies under 1 KHz. This is extremely limiting, inasmuch as a 5× increase in the number of LEDs needed for a given output (AC operation) is economically unacceptable, and even if rectified AC power is used, this peak-to-average problem causes a 2.5× increase in the number of LEDs versus DC operation.

The intended lack of large DC capacitors (e.g., lack of electrolytic capacitors) greatly improves the prognosis for long-term dependable operation, but this comes at the cost of adding many more LEDs. However, like the DC “series LED strings”, each LED must be electrically isolated from its neighbor and from its metallic mounting frame (which otherwise would be a good heat sink) because each LED is at a different AC line reference voltage requiring KV level isolation due to spikes. This approach lends itself to many small LEDs (such as those manufactured by LiteSheet Solutions of Bedford, Va.). The bulk of the high power market, however, currently remains with tens of larger LEDs, each with perhaps 3-5 watts or more of power. For a 200 watt equivalent light output (a common residential streetlight size), an LED system might have, for example, twenty 5 watt high power LEDs. Advantageously, only about 100 watts of total power is now needed to produce the 200 watt equivalent light output due to the higher efficiency of the LED lamps vs. gas-discharge lamps. This enables Applicant's magnetic or inductive energy storage concept (see below), by reducing the magnetic component size, cost and weight by a factor of approximately 2 compared to those presently widely used in gas-discharge lamps. This validates that “cost of the magnetics” is not a severe drawback.

AC or rectified AC (pulse DC) operation also produces strobe effects at 120 flashes per second, which can be a drawback in many applications (e.g., lighting near moving machines). Magnetic-ballasted gas-discharge lamps (e.g., fluorescent or high-intensity discharge (HID) lamps) also produce strobe effects, which are generally tolerated in outside lighting. Applicant's new stored magnetic energy approach with LEDs can minimize this by allowing a pseudo-constant current flow even across the AC current “zeros”.

### SUMMARY OF THE INVENTION

The present invention comprises the provision and use of a novel circuit for powering an LED lighting array such as for use in a streetlight mesh network. With the novel circuit, AC line current is first directed across a transformer to step down the voltage; the output of the transformer is passed through a rectifier bridge or, alternatively, the secondary windings of the transformer could be tapped and paired with steering diodes, whereby to provide a varying DC current; the varying DC current is passed through an inductor so as to smooth out the varying DC current, and then the smoothed-out DC current is directed to the LED lighting array to power the LEDs. Note that when the varying DC current is passed through the inductor, it is smoothed out with respect to both voltage and current.

If desired, a parallel “leakage core” leg may be provided on the transformer, and/or an AC capacitor may be provided on a winding of the transformer, to correct the power factor of the circuit and to address third harmonic issues.

The present invention also comprises an LED lighting array in combination with the aforementioned novel circuit.

An LED lighting array incorporating the novel circuit can be easily heat-sinked by grounding to the housing of the lighting fixture.

By providing a parallel “leakage core” leg on the transformer, and/or by providing an AC capacitor on the secondary winding of the transformer, the power factor of the circuit may be corrected. The “leakage core” leg creates a lagging power factor, and the AC capacitor creates a leading power factor. Both can be used to shift the current waveform so that the current waveform is more in phase with the voltage waveform, and thus the power factor is improved.

Importantly, the new circuit does not emit significant RFI since it uses an inductor to “smooth out” the waveform of the DC current which is passed to the LEDs, rather than using a regulator (which emits RFI due to high frequency switching). This enables the new circuit to be used to power an LED array in a streetlight mesh network because there is no significant RFI present to interfere with the Wi-Fi network.

Also, by using an inductor to “smooth out” the waveform of the DC current which is passed to the LEDs, flickering is inherently reduced by virtue of the power stored in the windings of the inductor.

And various nominal input voltage ranges are readily accommodated by transformer tappings or variable winding arrangement leads.

Significantly, because the new circuit lacks an electrolytic capacitor, the new circuit avoids the problem of the electrolytic capacitor drying out, which makes the circuit (and the LED lighting array incorporating the circuit) highly durable.

In one form of the invention, there is provided an LED area lighting fixture, the LED area lighting fixture comprising:

at least two low voltage LEDs; and

a passive magnetic energy storage device electrically connected to the at least two low voltage LEDs, wherein the passive magnetic energy storage device operates at 50 hertz or 60 hertz and protects the low voltage LEDs from power line disturbances via its inductive reactance, and further wherein the passive magnetic energy storage device has a designed-in controlled impedance and a magnetic energy storage characteristic designed to stabilize the wattage delivered to the LEDs.

In another form of the invention, there is provided an LED lighting fixture power supply, the LED lighting fixture power supply comprising a galvanically-isolated, controlled leakage reactance ballasting transformer, operating at 50 Hz or 60 Hz, and acting as, or electrically connected to, an inductive energy storage device.

In another form of the invention, there is provided an LED lighting fixture, the LED lighting fixture comprising:

a fixture body; and

a ballasting transformer, wherein at least one of the windings of the ballasting transformer is center-tapped, and further wherein the center tap is electrically connected to the fixture body.

In another form of the invention, there is provided an LED lighting fixture, the LED lighting fixture comprising:

a fixture body; and

a plurality of LED strings each having two ends, wherein all of the LED strings are inherently and passively operated under 42 Vrms over the fixture body voltage, and further wherein one end of each string is electrically connected to the fixture body for heatsinking.

In another form of the invention, there is provided an LED lighting fixture, the LED lighting fixture comprising a metallic fixture body and at least one LED, wherein the LED lighting fixture is operated on a grounded AC grid line voltage, and further wherein one side of the at least one LED is electrically connected directly to the metallic fixture body.

In another form of the invention, there is provided a circuit for powering an LED lighting array, the circuit comprising:

a transformer for receiving AC line current and stepping down the voltage;

one of a rectifier bridge or tapped secondary windings of the transformer paired with steering diodes, for providing a varying DC current;

an inductor for receiving the varying DC current so as to smooth out the varying DC current with respect to both voltage and current; and

a electrical connection for directing the smoothed-out DC current to the LED lighting array to power the LEDs.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts, and further wherein:

FIG. 1 is a schematic view showing one form of the present invention;

FIG. 2 is a schematic view showing another form of the present invention;

FIG. 3 is a schematic view showing still another form of the present invention;

FIG. 4 is a schematic view showing still another form of the present invention;

FIGS. 5A-5D are schematic views showing prior art constructions;

FIG. 5E is a schematic view showing another form of the present invention; and

FIG. 5F is a schematic view showing still another form of the present invention.

### DETAILED DESCRIPTION OF THE INVENTION

It has occurred to Applicant that, given the lower power requirements of LED lighting, and given the fact that the cost and size of magnetic components (2-3 times larger than the cost and size for non-magnetic components for the same light output) are tolerated in the millions of gas-discharge lamps (of 175 to 400 watt size) currently in use, a high-volume-production, magnetic component, rated at only 40% of the current KVA size, may be used without incurring prohibitive cost issues. This is especially true when considering the costs associated with (i) all of the capacitors and power electronic components required for the high frequency “switcher” type LED lighting, (ii) required heat-sinking of the semiconductor components of the LED lighting, (iii) preventing those components from radiating RFI, (iv) the surge suppression required to properly protect a high frequency, all-electronic “switcher” approach from 4 KV transients of high power, and (v) insulating the LEDs for long term use in damp environments at high voltages while heatsinking them. Furthermore, even when all of the foregoing is provided for high frequency “switcher” type LED lighting, there is no question that the reliability of all of these fragile components is less than an essentially “bulletproof” ballast transformer or ballast inductor which is used in the new, isolated, lower voltage magnetic energy storage lighting design of the present invention. Significantly, mercury vapor lamps using a passive magnetic reactor ballast system, from the late 1930's, still function well (albeit with improved mercury vapor-style lamps).

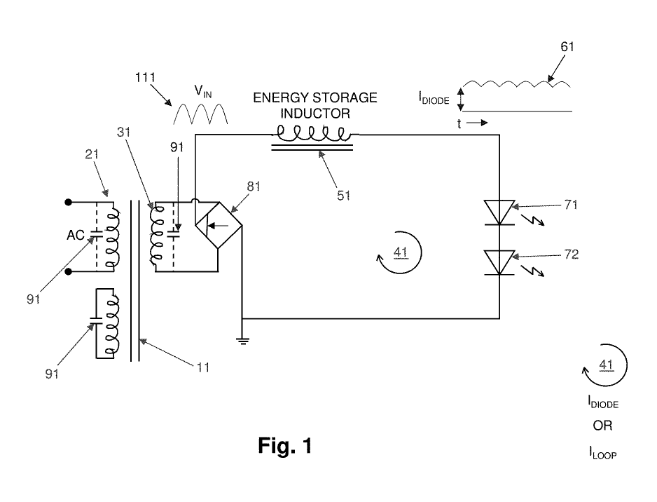

Given this insight, Applicant has recognized that one can take advantage of the galvanic isolation and arbitrary voltage ratios of a specially-designed high reactance transformer or transformer/DC inductor fixture configuration to provide a novel circuit for driving an LED lighting array. See the various embodiments shown in FIGS. 1, 2, 3, 4 and 5E, and which are discussed in further detail below. The novel circuit provides the following improvements, among others.

(1) Easily Heat-Sinkable.

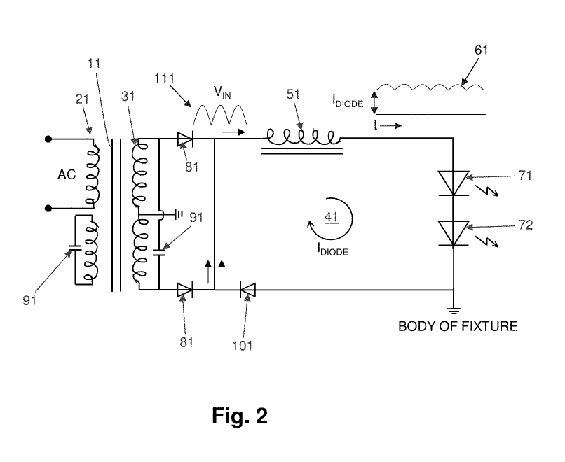

One side of the LED and power supply can be solidly bolted or grounded (uninsulated) to the aluminum housing of the lighting fixture, heat-sinking the LED array very well; by operating in small, center-tapped winding groups of LEDs (FIG. 1 or FIG. 2), the current can be easily stabilized over a typical range of nominal input voltages due to the inherent energy storage or ballasting action of a transformer or inductor designed to do exactly this. One known way is to provide a parallel magnetic “leakage core” leg, known from gas-discharge ballasts (note: much less dynamic range is needed here, inasmuch as LEDs are very stable relative to gas-discharge lamps and have no warmup or high voltage startup issues). By using comparatively inexpensive steering, bridge or rectifier diodes, or groups of LEDs with multiple secondary windings, one side of the LED or array can always be the earthed (grounded) side, connected to the structure, simplifying conduction cooling. Even if connected in series, the aggregate voltage at any exposed place can be held below the 42 Vrms which Underwriters Laboratory (UL) considers hazardous (i.e., about ten LEDs in series). This magnetic energy storage principle at 60 Hz allows various combinations of series parallel LED diodes, multiple windings, or both, without actively switching series/parallel configurations or connections. The LED diode current can be made close to optimal and is unrelated numerically to the peak line current (set by the transformer ratio or inductor design). Various fully-exposed, lightly-insulated heat sink arrangements can be envisioned. It should be appreciated that there are no high voltages on the diodes (a critical fact) due to the thorough galvanic isolation and step-down ratio.

(2) Power Factor Optimized.

Power factor can be addressed by an AC capacitor, by arranging the isolated transformer windings (as always, at least two windings) on separate bobbins, one winding can be a leakage winding (inductive reactive winding, or lagging power factor) and the other winding can be compensated by an AC capacitor network to draw a leading power factor (PF)—the sum can be made to be 90% PF or better (“normal PF”), solving the power factor and harmonic issues. Because the currents are phase-shifted, the harmonics are not as additive, and a major improvement results. The light output from each string of LEDs can be phase-shifted in time, tending to remove or reduce any flicker effects. This phase-shift concept, while not explicitly required, has been previously used in fluorescent lighting, but has not previously been used with low voltage, isolated windings or in LED lighting with one side at earth (ground) potential. Ceramic stacked film capacitors of small size and low voltage can enable this capacitive reactance at low cost.

(3) No RFI Emitted.

Because there is no high frequency switching, there is inherently no radiated or conducted RFI. An RFI problem simply does not exist—a critical advantage for the described mesh network-compatible LED light fixture when viewed as embedded in a digital system, or controlled by adjacent digital networks (e.g., a poletop-mounted LED light fixture controlled by a physically adjacent radio-based mesh network system such as a Wi-Fi network system). Stated another way, low frequency, 60 hertz LED lighting fixtures utilizing the present magnetic energy storage invention do not emit significant RFI. RFI is a significant problem with radio-based mesh network systems (such as Wi-Fi network systems) mounted to poletops adjacent to streetlights. It is almost impossible to adequately shield a 100 watt switching power supply located in proximity to a maximally sensitive broadband radio receiver (such receivers must have sensitivity in the 1-5 μV range, and are very wideband by nature). Noise in the receiver will block Wi-Fi-like uses. The present invention allows radio-based mesh network systems (such as next generation Wi-Fi-like network or meshed router systems) to be used adjacent to highly efficient LED streetlights. The present invention provides an LED lighting fixture power supply which produces little or no RFI and is highly reliable.

The LED power supply can also provide low voltage noise-free DC power to the Wi-Fi mesh network (or to another adjacent system such as a radio system) by a suitable interface such as a plug-and-socket configuration on the streetlight.

Control modifications of the system, with added “not in the critical path” parts, allows operation on a dimmer (inherently) or 0-10 volt signals, by add-in electronic boards, isolated from line voltage and powered from the low voltage DC already present. Failure of such add-in electronic boards would not, by design, shut down the basic LED lighting fixture or impact power to the Wi-Fi mesh network.

(4) Current Smoothed Out.

The reactance or effective impedance of the transformer or series inductor (choice) may be adjusted (by design) to tolerate LED imbalance issues, keeping currents near optimal. LED life is increased, as there are no startup or surge issues, etc. Further, the inductor reactance keeps the current flowing in the LED junctions even across the AC current “zeros”, due to power stored in its windings (½ LI²) as a smoothed circulating current, ideal for LED operation.

(5) Accommodates a Range of Input Voltages.

Various nominal input ranges are readily accommodated by transformer tappings or variable winding arrangement leads—120, 208 and 240, 277 in one design; 377, 480 and 600 in another input coil design. This wide range is difficult to accommodate with solid state PFC designs while keeping efficiency high.

### Some Preferred Embodiments

In FIG. 1, the transformer 11 is energized by an alternating current at the winding 21, which may be tapped to match various voltages. Transformer 11 may be a special high reactance transformer of various known configurations to help with regulation of an inductive current path 41.

The winding 31 provides a lower voltage (or any voltage) to inject current into the inductive current path shown by arrow 41, a circulating current. The inductive storage element 51 smoothes this current, tending to keep inductive current path 41 constant as shown by typical waveform 61.

Depending on the power of the LED fixture, inductive storage element 51 may store 0.04-1 joule or 1 Watt/second (without excluding other values) to keep the current circulating even as the fluctuating AC line voltage goes through “zero” crossings. This also helps with “flicker” as an engineering tradeoff.

Because of inductive storage element 51 being “on” at all times, the very non-linear IV characteristic of LEDs 71, 72, etc. is isolated from the line, and a fairly constant current is drawn from the line, improving power factor and reducing harmonics. Further reduction is possible by known methods, like power factor capacitors.

Furthermore, the active nature of inductive storage element 51 is isolated in an AC sense from the line by the diodes 81. Peaked AC line currents would otherwise reduce the power factor as happens with DC capacitor storage. The AC capacitors 91 are connected in known ways (such as those displayed), and will further improve the power factor as required.

The diodes 81 (in FIG. 1) or 81 and 101 (in FIG. 2) carry the circulating current during the time the AC line voltage is instantaneously low. The rectified AC voltage pulses 111 can be viewed as “pumping” the current loop 120 times per second while inductive storage element 51 sustains current 41 between “pumps”.

In the embodiment of FIG. 1, the bridge diode array 81 embodies the function of diodes 81 and 101 in FIG. 2, but has always at least two diodes in conduction, adding to losses.

In the embodiment of FIG. 2, efficiency may be improved for larger power versions depending on the ratio of storage-to-pump diode conduction intervals, due to less diode loss.

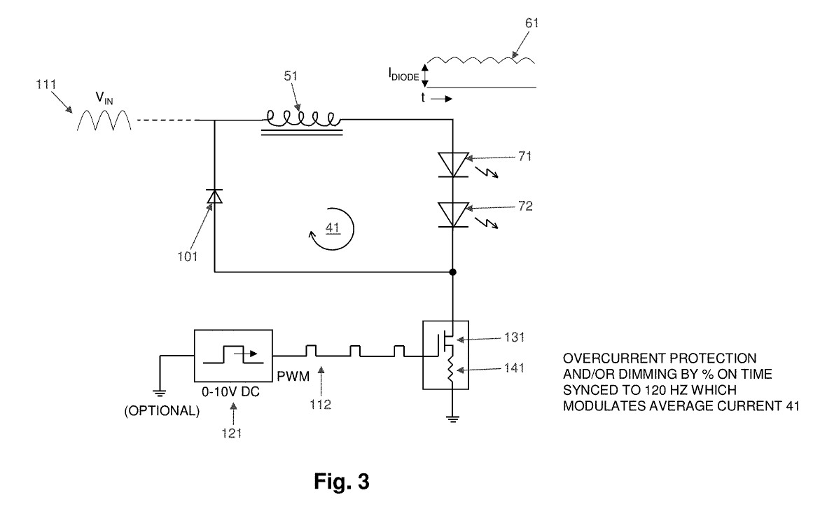

In the embodiment of FIG. 3, the pumping function can be modulated by a synchronized pulse width modulation (PWM) scheme 112 (details not shown) reducing the pump conduction and so offering a dimming function controlled by a 0-10V signal 121.

This same arrangement, using a field-effect transistor (FET), bipolar junction transistor (BJT) or insulated-gate bipolar transistor (IGBT), at 131, as a control switch for brightness, can also protect against overcurrent in the system by current sense 141, which tends to turn off FET, BJT or IGBT 131 if the current rises above a threshold (excessive line voltage).

Various series parallel arrangements can be substituted for LEDs 71, 72 as a part of optimization of the design. In reality, many more diodes are in place than the LEDs 71, 72 drawn in the figures.

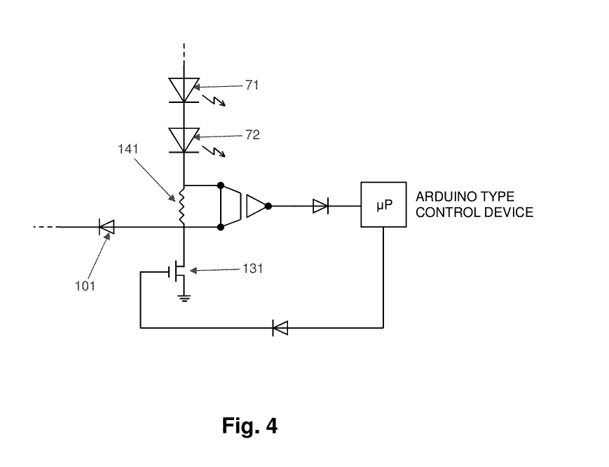

In the embodiment of FIG. 4, the function of the controlled pump current (and thus energy per pulse) allowed by FET, BJT or IGBT 131 can be combined with current sense 141 so as to enable a feedback loop via FET, BJT or IGBT 131 that regulates the average current in inductive current path 41 actively, by the known methods outlined in the section entitled “(4) Current Smoothed Out” above.

By the concepts shown herein, a novel circuit for powering an LED area light is provided that emits substantially no RFI, enabling use of the circuit (and an LED light array driven by the circuit) with Wi-Fi or mesh networks.

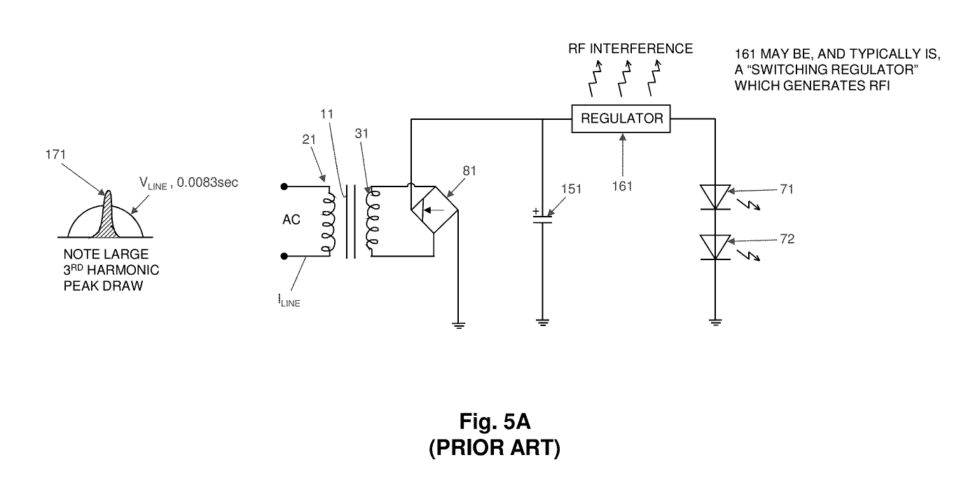

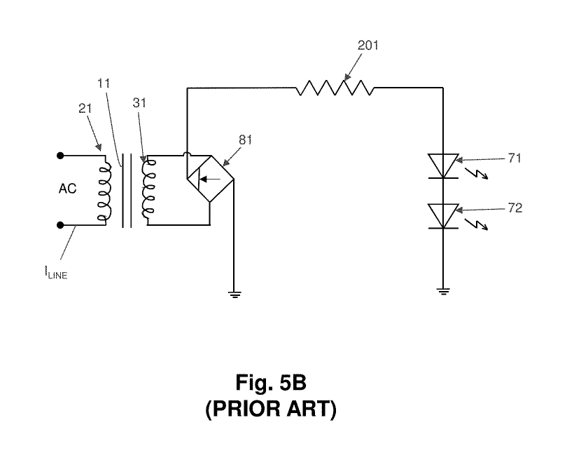

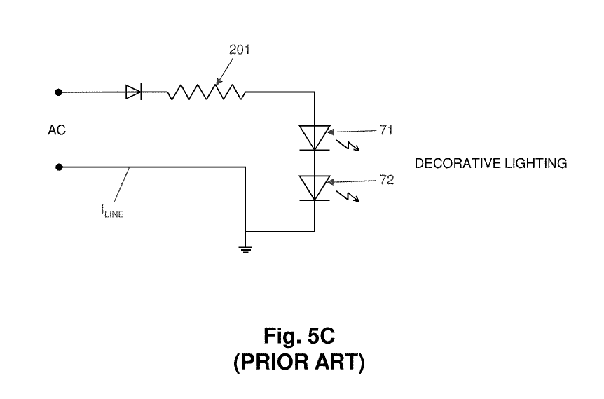

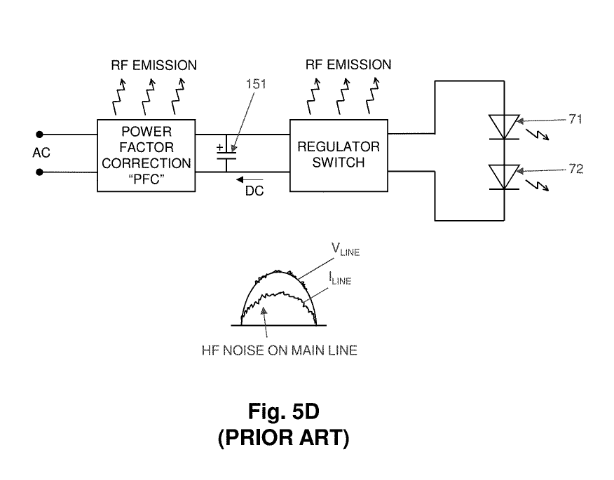

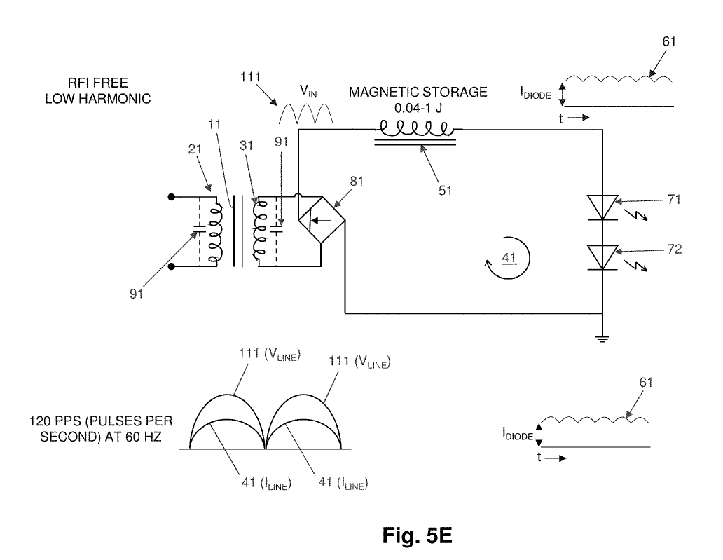

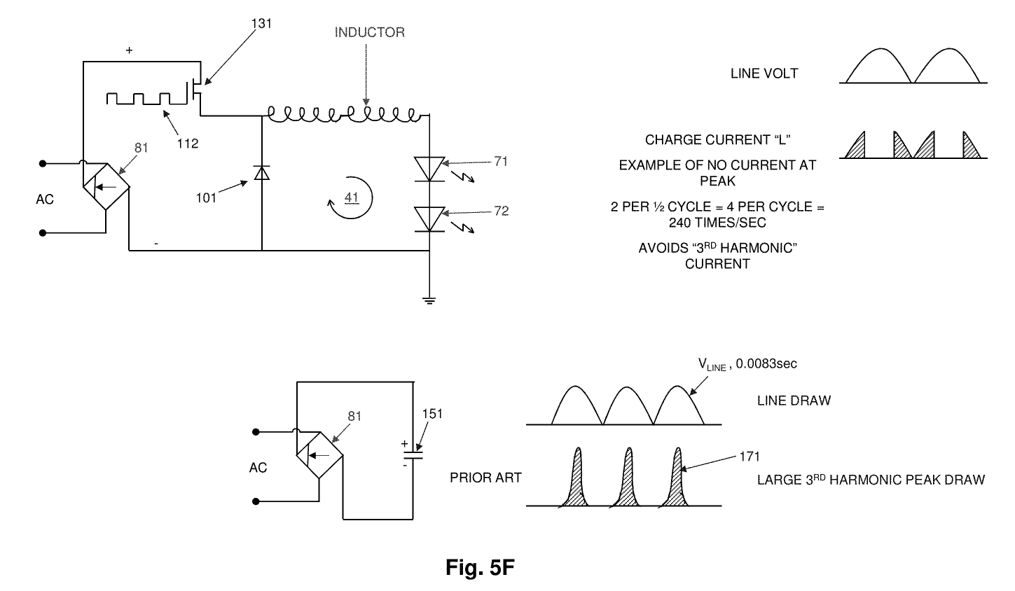

FIG. 5A (prior art) shows a normal DC bridge power supply with filter capacitor 151, followed by a regulator 161. This results in high third harmonic currents, shown at 171. Third harmonics add in 3 phase systems, and are therefore to be avoided in large area lighting.

FIG. 5B (prior art) suffers from third harmonics due to the diodes only coming on at voltage peaks. For thermal peak temperature reasons, approximately 2.6 times as many LED diodes are needed on AC direct operation for the same DC light output as the constructions shown in FIGS. 5A, 5D (see below) or 5E (see below). Heat cannot be averaged at line frequency; the DC limit still applies to the peak, and the LED diodes are off between the peaks. The construction of FIG. 5B loses much power in ballast 201.

FIG. 5C (prior art) is essentially the same as FIG. 5B. It is sometime advocated for lower cost, but now requires approximately 5.4 times as many diodes for the same light output. This construction is used in low power decorative LED lighting.

FIG. 5D (prior art) is the conventional approach for driving LEDs, still requiring energy storage via electrolytic capacitor 151, and generating copious amounts of RFI. “Power factor correction” (PFC) schemes also require switching, again generating RFI.

FIG. 5E is another embodiment of the new concept of the present invention, free of RFI, no electrolytic capacitor, and uses magnetic storage of energy in a low frequency inductive storage element 51, resulting in a smooth current draw 41.

FIG. 5F shows how the line draw may be shaped and allow a smaller inductor to be used if refreshed “more often” than once per line cycle.

### Modifications of the Preferred Embodiments

It should be understood that many additional changes in the details, materials, steps and arrangements of parts, which have been herein described and illustrated in order to explain the nature of the present invention, may be made by those skilled in the art while still remaining within the principles and scope of the invention.

What is claimed is:

1. An LED area lighting fixture, the LED area lighting fixture comprising:
at least two low voltage LEDs; and
a passive magnetic energy storage device electrically connected to the at least two low voltage LEDs, wherein the passive magnetic energy storage device operates at 50 hertz or 60 hertz and protects the low voltage LEDs from power line disturbances via its inductive reactance, and further wherein the passive magnetic energy storage device has a designed-in controlled impedance and a magnetic energy storage characteristic designed to stabilize the wattage delivered to the LEDs.

2. An LED area lighting fixture according to claim 1 further comprising an AC rated film capacitor electrically connected to an alternating current voltage difference within the fixture.

3. An LED area lighting fixture according to claim 2 further comprising 2 or 4 power diodes used to obtain a pulsating DC voltage waveform from an AC voltage waveform, and wherein the passive magnetic energy storage device stores between 0.04 and 10 Joules of magnetic energy.

4. An LED area lighting fixture according to claim 1 wherein energy is added to the passive magnetic energy storage device between 100 and 1000 times per second, and is phased to a power line sine wave voltage.

5. An LED area lighting fixture according to claim 1 wherein the passive magnetic energy storage device comprises an inductor.

6. An LED lighting fixture power supply, the LED lighting fixture power supply comprising a galvanically-isolated, controlled leakage reactance ballasting transformer, operating at 50 Hz or 60 Hz, and acting as, or electrically connected to, an inductive energy storage device.

7. An LED lighting fixture power supply according to claim 6 further comprising an AC rated film capacitor electrically connected to an alternating current voltage difference within the LED lighting fixture power supply.

8. An LED lighting fixture power supply according to claim 7 further comprising 2 or 4 power diodes used to obtain a pulsating DC voltage waveform from an AC voltage waveform, and wherein the ballasting transformer or inductive energy storage device stores between 0.04 and 10 Joules of magnetic energy.

9. An LED lighting fixture power supply according to claim 6 wherein the inductive energy storage device comprises an inductor.

10. An LED lighting fixture, the LED lighting fixture comprising:
a fixture body; and
a ballasting transformer, wherein at least one of the windings of the ballasting transformer is center-tapped, and further wherein the center tap is electrically connected to the fixture body.

11. An LED lighting fixture according to claim 10 further comprising an AC rated film capacitor electrically connected to an alternating current voltage difference within the LED lighting fixture.

12. An LED lighting fixture according to claim 11 further comprising (i) 2 or 4 power diodes used to obtain a pulsating DC voltage waveform from an AC voltage waveform, and (ii) an inductive energy storage device storing between 0.04 and 10 Joules of magnetic energy.

13. An LED lighting fixture according to claim 12 wherein the inductive energy storage device comprises an inductor.

14. An LED lighting fixture, the LED lighting fixture comprising:
a fixture body; and
a plurality of LED strings each having two ends, wherein all of the LED strings are inherently and passively operated under 42 Vrms over the fixture body voltage, and further wherein one end of each string is electrically connected to the fixture body for heatsinking.

15. An LED lighting fixture according to claim 14 further comprising an AC rated film capacitor electrically connected to an alternating current voltage difference within the LED lighting fixture.

16. An LED lighting fixture according to claim 15 further comprising (i) 2 or 4 power diodes used to obtain a pulsating DC voltage waveform from an AC voltage waveform, and (ii) an inductive energy storage device storing between 0.04 and 10 Joules of magnetic energy.

17. An LED lighting fixture according to claim 16 wherein the inductive energy storage device comprises an inductor.

18. An LED lighting fixture, the LED lighting fixture comprising a metallic fixture body and at least one LED, wherein the LED lighting fixture is operated on a grounded AC grid line voltage, and further wherein one side of the at least one LED is electrically connected directly to the metallic fixture body.

19. A circuit for powering an LED lighting array, the circuit comprising:
a transformer for receiving AC line current and stepping down the voltage;
one of a rectifier bridge or tapped secondary windings of the transformer paired with steering diodes, for providing a varying DC current;
an inductor for receiving the varying DC current so as to smooth out the varying DC current with respect to both voltage and current; and
a electrical connection for directing the smoothed-out DC current to the LED lighting array to power the LEDs.

20. A circuit according to claim 19 wherein the circuit further comprises at least one of a parallel “leakage core” leg on the transformer, and an AC capacitor provided on a winding of the transformer, to correct the power factor of the circuit and to address third harmonic issues.

21. A circuit according to claim 19 further comprising an LED lighting array.
